(19) United States
(12) Patent Application Publication
(10) Pub. No.: US 2025/0234419 A1
(43) Pub. Date: Jul. 17, 2025

(54) METHOD AND DEVICE FOR ENHANCING SECURITY IN AS LAYER IN NEXT-GENERATION MOBILE COMMUNICATION SYSTEM

(71) Applicant: Samsung Electronics Co., Ltd., Gyeonggi-do (KR)

(72) Inventors: Seungri JIN, Gyeonggi-do (KR); Anil AGIWAL, Gyeonggi-do (KR); Donggun KIM, Gyeonggi-do (KR)

(21) Appl. No.: 18/700,498

(22) PCT Filed: Oct. 28, 2022
(86) PCT No.: PCT/KR2022/016680

§ 371 Date: Apr. 11, 2024

(30) Foreign Application Priority Data
Oct. 29, 2021 (KR) 10-2021-0147213

(51) Int. Cl. H04W 76/27; H04W 12/106

(52) U.S. Cl. CPC H04W 76/27; H04W 12/106

(57) ABSTRACT

The present disclosure provides a method performed by means of a terminal in a wireless communication system. The method may comprise the steps of: acquiring information including a Message Authentication Code for Integrity (MAC-I) in an RRC idle state; verifying the MAC-I; and performing a procedure for an RRC connection with a base station if the MAC-I is valid on the basis of the verification.

### TECHNICAL FIELD

The present disclosure relates to a method and a device for enhancing the security function against false base station(s) (FBS) in a wireless communication system.

### BACKGROUND ART

5G mobile communication technologies define broad frequency bands such that high transmission rates and new services are possible, and may be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next generation distributed computing technology for implementing services at levels of complexity exceeding the limit of UE operation capability by utilizing ultra-high-performance communication and computing resources.

### DISCLOSURE OF INVENTION

### Technical Problem

The present disclosure provides a method and a device for enhancing the security function against false base station(s) (FBS) in a wireless communication system. More specifically, it provides a method for enhancing the security capability for the messages to which the security is not applied among NR radio resource control (RRC) messages.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

A method performed by a UE in a wireless communication system according to an embodiment of the present disclosure may comprise the steps of: acquiring information including a Message Authentication Code for Integrity (MAC-I) in an RRC idle state; performing a verification for the MAC-I; and performing a procedure for an RRC connection with a base station in case that the MAC-I is valid based on the verification.

A method performed by a base station in a wireless communication system according to an embodiment of the present disclosure may comprise the steps of determining a MAC-I to be transmitted to a UE in an RRC idle state and transmitting information including the determined MAC-I to the UE, and a procedure for RRC connection with the UE may be performed in case that the MAC-I is valid.

In a wireless communication system according to an embodiment of the present disclosure, a UE may include a transceiver and a controller configured to acquire information including a MAC-I in an RRC idle state, perform a verification for the MAC-I, and perform a procedure for an RRC connection with a base station in case that the MAC-I is valid based on the verification.

In a wireless communication system according to an embodiment of the present disclosure, a base station may include a transceiver and a controller configured to determine MAC-I to be transmitted to a UE in an RRC idle state and transmit information including the determined MAC-I to the UE, and a procedure for RRC connection with the UE may be performed in case that the MAC-I is valid.

### Advantageous Effects of Invention

According to an embodiment of the present disclosure, by introducing security enhancement techniques, a UE receiving services in a wireless communication system (e.g., a 5G network) may be able to perform integrity checks on RRC messages of a particular access stratum (AS) layer, thereby becoming secure against security-related attacks by the FBS.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 illustrates a structure of an LTE system according to an embodiment of the present disclosure.

FIG. 2 illustrates a wireless protocol structure in an LTE system according to an embodiment of the present disclosure.

FIG. 3 illustrates a structure of a next generation mobile communication system according to an embodiment of the present disclosure.

FIG. 4 illustrates a wireless protocol structure of a next generation mobile communication system according to an embodiment of the present disclosure.

FIG. 5 illustrates a structure of a security technique using a symmetric key and an asymmetric key according to an embodiment of the present disclosure.

FIG. 6 is a diagram illustrating a method of delivering a MAC-I through system information, determining its validity based on a symmetric key and an asymmetric key, and applying it to an RRC message, according to an embodiment of the present disclosure.

FIG. 7 is a diagram illustrating a UE operation supporting an enhanced security function when a new MAC-I is included in a system information, according to an embodiment of the present disclosure.

FIG. 8 is a diagram illustrating a UE operation supporting an enhanced security function when a new MAC-I is included in a dedicated RRC message, according to an embodiment of the present disclosure.

FIG. 9 is a diagram illustrating the overall operation of a base station supporting an enhanced security function when a new MAC-I is included, according to an embodiment of the present disclosure.

FIG. 10 is a diagram illustrating a block configuration of a UE according to an embodiment of the present disclosure.

FIG. 11 is a diagram illustrating a block configuration of a base station according to an embodiment of the present disclosure.

### MODE FOR INVENTION

Hereinafter, the operating principle of the present disclosure will be described in detail with reference to the attached drawings.

In the following description of the present disclosure, if a detailed description of a related known function or configuration is judged to unnecessarily obscure the essence of the present disclosure, the detailed description will be omitted. In addition, the terms described below are defined in consideration of the functions in the present disclosure and may vary depending on the intention or custom of the user or the operator. Therefore, the definitions should be taken in the context of the entire specification.

As used in the following description, terms for identifying access nodes, terms for referring to network entities, terms for referring to messages, terms for referring to interfaces between network entities, and terms for referring to various identifying information are exemplified for ease of explanation. Accordingly, the disclosure is not limited to the terms described herein, and other terms may be used to refer to objects having equivalent technical meaning.

For the convenience of the following description, the present disclosure uses the terms and names defined as defined in the 3rd Generation Partnership Project (3GPP) LTE standard. However, the present disclosure is not limited by these terms and names and may be equally applicable to systems complying with other standards.

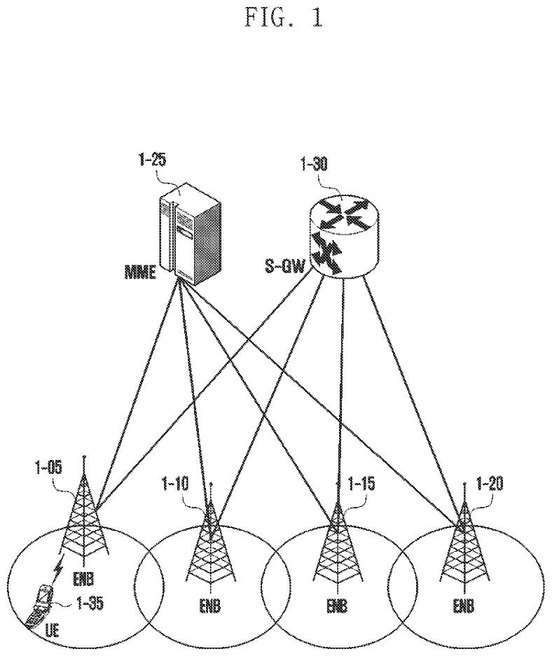

FIG. 1 illustrates a structure of an LTE system according to an embodiment of the present disclosure.

With reference to FIG. 1, as shown, the radio access network of an LTE system may be constituted of a next generation base station (Evolved Node B, hereinafter, referred to as eNB, Node B, or base station) 1-05, 1-10, 1-15, and 1-20, a Mobility Management Entity (MME) 1-25, and a Serving-Gateway (S-GW) 1-30. A user equipment (hereinafter, UE, or terminal) 1-35 may access the external network through eNB 1-05 to 1-20 and S-GW 1-30.

In FIG. 1, eNB 1-05 to 1-20 corresponds to existing Node B of the UMTS system. The eNB is connected to the UE 1-35 through a wireless channel and performs a more complex role than the existing Node B. In an LTE system, as all user traffics, including real-time services such as VoIP (Voice over IP) through the Internet Protocol, are serviced through a shared channel, a device is needed to perform scheduling by collecting status information such as a buffer status, an available transmission power status, and a channel status of UEs, and eNBs 1-05 to 1-20 are responsible for this. One eNB typically controls multiple cells. For example, to implement a transmission speed of 100 Mbps, the LTE system uses Orthogonal Frequency Division Multiplexing (hereinafter, referred to as OFDM) as a wireless access technology in, for example, a 20 MHz bandwidth. In addition, the Adaptive Modulation & Coding (AMC) method, which determines the modulation scheme and the channel coding rate according to the channel status of the UE, is applied. The S-GW 1-30 is a device that provides data bearers and creates or removes data bearers under the control of the MME 1-25. The MME is connected to multiple base stations as a device that handles various control functions as well as mobility management functions for the UE.

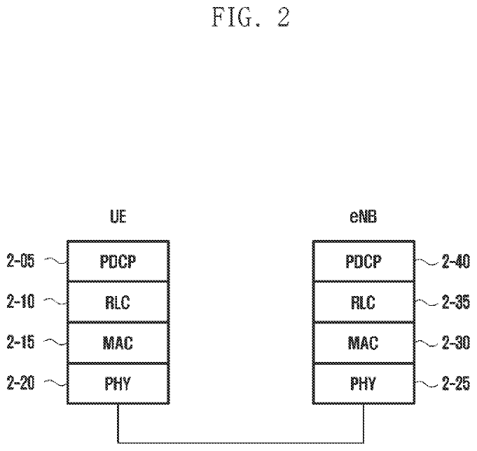

FIG. 2 illustrates a wireless protocol structure in an LTE system according to an embodiment of the present disclosure.

With reference to FIG. 2, the wireless protocols of an LTE system may consist of Packet Data Convergence Protocol (PDCP) 2-05 and 2-40, Radio Link Control (RLC) 2-10 and 2-35, and Medium Access Control (MAC) 2-15 and 2-30 at the UE and eNB, respectively.

The PDCP 2-05 and 2-40 is responsible for operations such as IP header compression/restoration. The main functions of the PDCP may be summarized as follows:
Header compression and decompression, ROHC only,
Transfer of user data,
In-sequence delivery of upper layer PDUs at PDCP re-establishment procedure for RLC AM,
For split bearers in DC (only support for RLC AM): PDCP PDU routing for transmission and PDCP PDU reordering for reception,
Duplicate detection of lower layer SDUs at PDCP re-establishment procedure for RLC AM,
Retransmission of PDCP SDUs at handover and, for split bearers in DC, of PDCP PDUs at PDCP data-recovery procedure, for RLC AM,
Ciphering and deciphering, and/or
Timer-based SDU discard in uplink.

The Radio Link Control (hereinafter referred to as RLC) 2-10 and 2-35 reconfigures PDCP Packet Data Units (PDUs) to the appropriate size and performs ARQ operations, etc. The main functions of the RLC may be summarized as follows:
Transfer of upper layer PDUs,
Error Correction through ARQ (only for AM data transfer),
Concatenation, segmentation and reassembly of RLC SDUs (only for UM and AM data transfer),
Re-segmentation of RLC data PDUs (only for AM data transfer),
Reordering of RLC data PDUs (only for UM and AM data transfer),
Duplicate detection (only for UM and AM data transfer),
Protocol error detection (only for AM data transfer),
RLC SDU discard (only for UM and AM data transfer), and/or
RLC re-establishment function.

The MAC 2-15 and 2-30 is connected to multiple RLC layer devices configured in a UE and performs multiplexing of RLC PDUs into MAC PDUs and demultiplexing of RLC PDUs from MAC PDUs. The main functions of the MAC may be summarized as follows:
Mapping between logical channels and transport channels,
Multiplexing/demultiplexing of MAC SDUs belonging to one or different logical channels into/from transport blocks (TB) delivered to/from the physical layer on transport channels,
Scheduling information reporting function,
Error correction through HARQ,
Priority handling between logical channels of one UE,
Priority handling between UEs by means of dynamic scheduling,
MBMS service identification function,
Transport format selection, and/or
Padding function.

The physical layer 2-20 and 2-25 performs the operations of channel-coding and modulating the upper layer data into OFDM symbols and transmitting through the wireless channel, or demodulating and channel-decoding the OFDM symbols received through the wireless channel and delivering them to the upper layer. In addition, the physical layer also uses HARQ (Hybrid ARQ) for additional error correction, and the receiver transmits one bit to indicate whether the packet sent by the transmitter was received or not. This is called HARQ ACK/NACK information. The downlink HARQ ACK/NACK information for uplink transmission may be transmitted through the PHICH (Physical Hybrid-ARQ Indicator Channel) physical channel, and the uplink HARQ ACK/NACK information for downlink transmission may be transmitted through the PUCCH (Physical Uplink Control Channel) or PUSCH (Physical Uplink Shared Channel) physical channel.

Meanwhile, the PHY layer may consist of one or multiple frequencies/carriers, and the technology that simultaneously configures and uses multiple frequencies is called carrier aggregation (hereinafter referred to as CA). The CA technology may dramatically increase the transmission volume by the number of secondary carriers, instead of using only one carrier for communication between the terminal (or User Equipment, UE) and the base station (E-UTRAN NodeB, eNB), by using the main carrier and one or more additional secondary carriers. In LTE, the cell in the base station that uses the primary carrier is called PCell (Primary Cell), and the cell that uses the secondary carrier is called SCell (Secondary Cell).

Although not shown in FIG. 2, there may be a Radio Resource Control (RRC) layer above the PDCP layer of the UE and the base station, respectively, and the RRC layer may send and receive connection and measurement-related configuration control messages for the radio resource control.

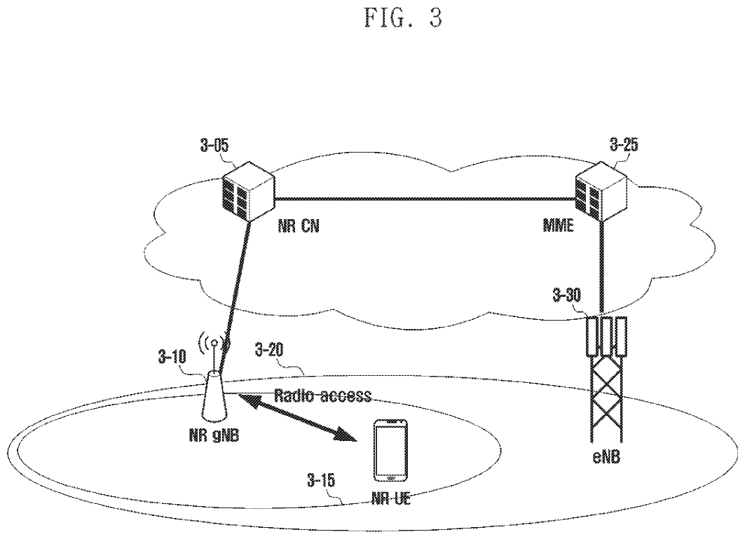

FIG. 3 illustrates a structure of a next generation mobile communication system according to an embodiment of the present disclosure.

With reference to FIG. 3, the radio access network of a next generation mobile communication system may be constituted of a New Radio Node B (hereinafter referred to as NR NB) 3-10 and a New Radio Core Network (NR CN or Next Generation Core Network (NG CN)) 3-05. The New Radio User Equipment (hereinafter NR UE or terminal) 3-15 may access the external network through the NR NB 3-10 and the NR CN 3-05. Here the NR CN 3-05 may be used interchangeably as a 5G Core Network (5G CN) or 5G Core (5GC).

In FIG. 3, the NR NB 3-10 may correspond to an Evolved Node B (eNB) of the legacy LTE system. The NR NB may be connected to the NR UE 3-15 by a wireless channel and provide a far better service than the existing Node B. In next-generation mobile communication systems, all user traffic is served through a shared channel and therefore, a device that aggregates status information such as buffer status of UEs, available transmission power status, channel status, etc. and performs scheduling is required and the scheduling is performed by NR NB 3-10. One NR NB may control usually multiple cells. Bandwidths beyond the typical maximum bandwidth may be applied to realize ultra-high speed data transmission compared to the legacy LTE and the beamforming technology may be additionally applied using Orthogonal Frequency Division Multiplexing (OFDM) as a wireless access technology. In addition, the Adaptive Modulation & Coding (AMC) method, which determines the modulation scheme and channel coding rate according to the channel condition of the UE, may be applied.

The NR CN 3-05 may perform functions such as mobility support, bearer configuration, and QoS configuration. The NR CN may be connected to the multiple base stations as a device responsible for various control functions as well as mobility management functions for the UE. In addition, the next-generation mobile communication system may also be interworked with the legacy LTE system, and the NR CN may be connected to the MME 3-25 through a network interface. The MME may be connected to an LTE base station, the eNB 3-30.

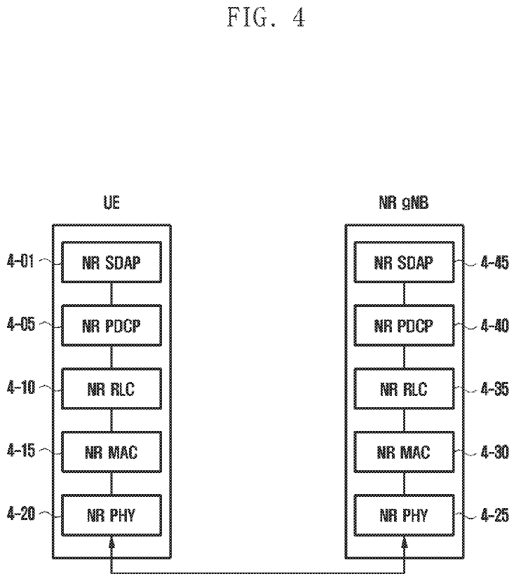

FIG. 4 illustrates a wireless protocol structure of a next generation mobile communication system according to an embodiment of the present disclosure.

With reference to FIG. 4, the wireless protocols of a next-generation mobile communication system may consist of NR Service Data Adaptation Protocol (SDAP) 4-01 and 4-45, NR PDCP 4-05 and 4-40, NR RLC 4-10 and 4-35, and NR MAC 4-15 and 4-30 at the UE and the NR base station, respectively.

The main functions of NR SDAP 4-01 and 4-45 may include some of the following functions:
transfer of user plane data,
mapping between a QoS flow and a DRB for both DL and UL,
marking QoS flow ID in both DL and UL packets for uplink and downlink, and/or
reflective QoS flow to DRB mapping for the UL SDAP PDUs.

For SDAP layer devices, the UE may be configured by RRC message whether to use the SDAP layer device header or the functions of the SDAP layer device on a PDCP layer device level, a bearer level, or a logical channel level, and, if the SDAP header is used, the UE may use the NAS QoS reflective setting 1-bit indicator (NAS reflective QoS) and the AS QoS reflective setting 1-bit indicator (AS reflective QoS) in the SDAP header to instruct the UE to update or reconfigure the QoS flows and mapping information for uplink and downlink data bearers. The SDAP header may include QoS flow ID information indicating the QoS. The QoS information may be used as data processing priorities, scheduling information, etc. to support seamless service.

The main functions of NR PDCP 4-05 and 4-40 may include some of the following functions:
Header compression and decompression: ROHC only,
Transfer of user data,
In-sequence delivery of upper layer PDUs,
Out-of-sequence delivery of upper layer PDUs,
PDCP PDU reordering for reception,
Duplicate detection of lower layer SDUs,
Retransmission of PDCP SDUs,
Ciphering and deciphering, and/or
Timer-based SDU discard in uplink.

In the above, the reordering function of the NR PDCP device means the function of reordering PDCP PDUs received from the lower layer based on PDCP sequence numbers (SN), and may include a function of delivering the data to the upper layer in the reordered order or a function of delivering the data directly without considering the order, may include a function of recording the lost PDCP PDUs after rearranging the order, may include a function of reporting the status of the lost PDCP PDUs to the transmitting side, and may include a function of requesting retransmission of the lost PDCP PDUs.

The main functions of NR RLC 4-10 and 4-35 may include some of the following functions:
Transfer of upper layer PDUs,
In-sequence delivery of upper layer PDUs,
Out-of-sequence delivery of upper layer PDUs,
Error Correction through ARQ,
Concatenation, segmentation and reassembly of RLC SDUs,
Re-segmentation of RLC data PDUs,
Reordering of RLC data PDUs,
Duplicate detection function,
Protocol error detection,
RLC SDU discard, and/or
RLC re-establishment.

In the above, the in-sequence delivery function of the NR RLC device means the function of delivering RLC SDUs received from the lower layer to the higher layer in order, and in the case that one RLC SDU is originally received by being divided into multiple RLC SDUs, the in-sequence delivery function of the NR RLC device may include the function of reassembling and delivering it, may include a function to rearrange the received RLC PDUs based on the RLC SN (sequence number) or PDCP SN (sequence number), may include a function of recording the lost RLC PDUs after rearranging the order, may include a function of reporting the status of the lost RLC PDUs to the transmitting side, may include a function of requesting retransmission of the lost RLC PDUs, may include a function of delivering only the RLC SDUs to the upper layer in order up to the lost RLC SDU when there is a lost RLC SDU, may include a function of delivering all RLC SDUs received before the timer starts to the upper layer in order if a predetermined timer expires even if there is a lost RLC SDU, and may include a function of delivering all RLC SDUs received to date to the upper layer in order if a predetermined timer expires even if there is a lost RLC SDU. In addition, in the above, the NR RLC device may process RLC PDUs in the order they are received (in the order of arrival regardless of the sequence number) and deliver them to the NR PDCP device (out-of-sequence delivery), and in the case of a segment, it may receive segments stored in a buffer or to be received later, reconstruct them into one complete RLC PDU, and then transmit it to the NR PDCP device. The NR RLC layer may not include a concatenation function, and may perform the function in the NR MAC layer or replace it with the multiplexing function of the NR MAC layer. In the above, the out-of-sequence delivery function of the NR RLC device means the function of directly delivering RLC SDUs received from a lower layer to the upper layer regardless of their order, and may include a function of reassembling and delivering when one RLC SDU is originally received by being divided into several RLC SDUs, and may include a function of storing the RLC SN or PDCP SN of received RLC PDUs, sorting the order, and recording lost RLC PDUs.

The NR MAC 4-15 and 4-30 may be connected to multiple NR RLC layer devices configured in one UE, and the main functions of NR MAC may include some of the following functions:
Mapping between logical channels and transport channels,
Multiplexing/demultiplexing of MAC SDUs,
Scheduling information reporting,
Error correction through HARQ,
Priority handling between logical channels of one UE,
Priority handling between UEs by means of dynamic scheduling,
MBMS service identification function,
Transport format selection, and/or
Padding function.

The NR PHY layer 4-20 and 4-25 may perform the operations of channel-coding and modulating the upper layer data into OFDM symbols and transmitting through the wireless channel, or demodulating and channel-decoding the OFDM symbols received through the wireless channel and delivering them to the upper layer.

The present disclosure proposes solutions at the access stratum (AS) level to address security vulnerability issues in current 5G networks identified in SA3's stage 2 study, “Study on the support for 5G security enhancement against False Base Stations (FBS)”. With reference to TR 33.809, the current 5G system may have the following security vulnerabilities for FBS:
1. DoS (Denial-of-Service) attack on the UE: Interfering the UE's connection to the network;
2. DoS (Denial-of-Service) attack on the network: Interfering the delivery of network services to the UE;
3. Log service attack: Delivering unauthorized services to the UE; and/or
4. Subscriber privacy attack: Acquiring private subscription information of the UE. In particular, certain RRC messages at the AS layer may not be subject to the integrity protection because they may be delivered prior to AS security activation. For example, UECapabilitylnformation, UECapabilityEnquiry, or RRCReject messages may not be subject to the integrity protection because they may be delivered prior to AS security activation.

As a specific example, depending on the implementation of the network, the base station may deliver a UECapabilityEnquiry message to the UE prior to AS security activation, and the UE may deliver a UECapabilityInformation message to the base station in response to the request. Both of the above messages may be delivered through signaling radio bearer 1 (SRB1) prior to AS security activation. In this case, a problem may arise where the FBS acquires UECapabilityInformation in the middle, sets it to a low level UE capability, and transmits it to the base station.

As another specific example, the cause value in the RRCResumeRequest message may not have an integrity protection through the Resume Message Authentication Code-Integrity (ResumeMAC-I). When the UE initiates the RRC resume procedure, the UE may deliver an RRCResumeRequest message containing ResumeMAC-I and inactive-RNTI (I-RNTI) to the base station, and the base station may set a waiting timer for the request and deliver an RRCReject message to the UE. That is, the base station may deliver the intention to the UE that an RRC resume request should be requested to make an RRC resume request again after the waiting timer ends as it is busy now. However, if the above RRCResumeRequest is exposed to the FBS, the FBS may deliver the RRCResumeRequest to the new base station while the waiting timer is running, causing the UE context to be delivered to the new base station. In this case, the procedure may fail even if the actual UE delivers the RRCResumeRequest back to the base station after the end of the waiting timer to request an RRC resume.

The present disclosure provides a method and a device for introducing a new Message Authentication Code-Integrity (MAC-I) so that integrity checks can be performed on RRC messages that were not subject to AS security activation, as a way to fundamentally solve the above problems.

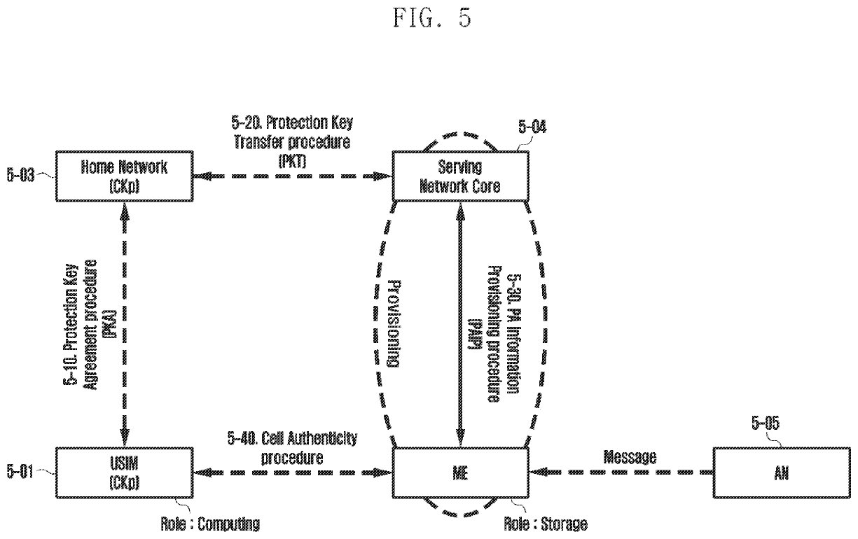

FIG. 5 illustrates a structure of a security technique using a symmetric key and an asymmetric key according to an embodiment of the present disclosure.

With reference to FIG. 5, the method of using a symmetric key in four steps is explained, and the same procedure may also be applied to an asymmetric key. FIG. 5 is an example only and the specific operation may be changed.

The UE 5-02 has a Universal Subscriber Identity Module (USIM) 5-01 inside, which is used to receive services from different operators (Public Land Mobile Network (PLMN)). The home network 5-03 and the USIM, which is responsible for subscription authentication, may directly exchange information, and in terms of security, they may share security keys through the Protection Key Agreement procedure 5-10. If a symmetric key is used at this stage, the home network 5-03 and the USIM may share the same security key and apply it to the integrity check. On the other hand, if an asymmetric key is used, the device is provided with a public key, and the home network 5-03/core network 5-04 may have a private key associated with the public key and may use it for integrity check. The private key should not be shared and may only be used within the network.

In the present disclosure, the symmetric key and the asymmetric key may have a structure in which they are generated and delivered to the UE USIM based on PLMN. That is, the security key may be generated and managed according to the subscription information of the UE.

In step 5-20, the home network 5-03 may deliver the security key associated with a particular UE to the core network 5-04. The core network that receives the security key may, in step 5-30, provision an area (e.g., a valid area) where the security key is applied to the UE and the integrity check is performed. The information about the area (i.e., the valid area) may be at least one of a cell level, a tracking area (TA)/registration area (RA) level, or a RAN notification area (RNA) level. Afterwards, the information about the new MAC-I and the above valid area may be delivered to the UE through system information.

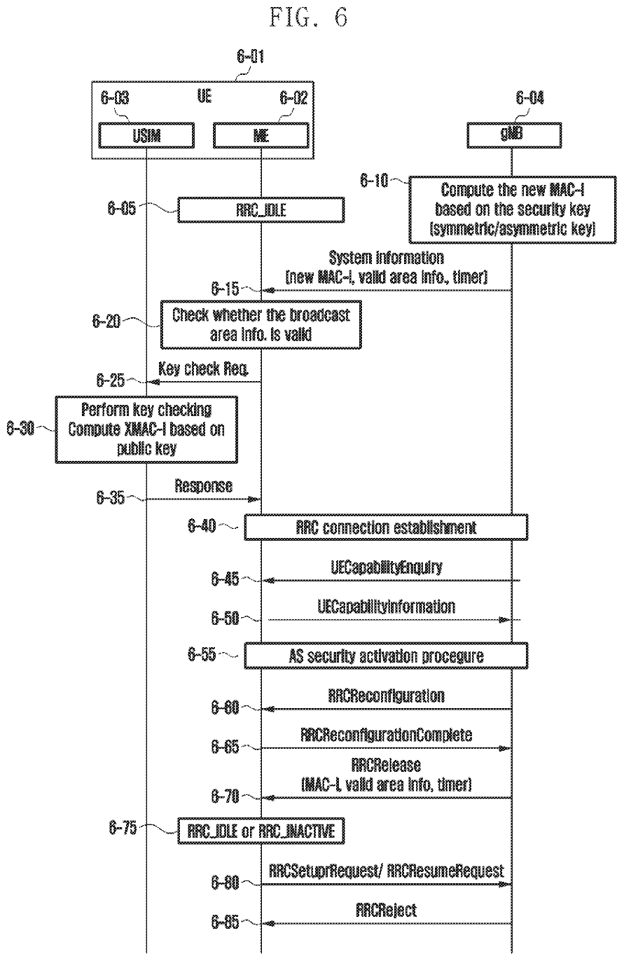

FIG. 6 is a diagram illustrating a method of delivering a MAC-I through system information, determining its validity based on symmetric and asymmetric keys, and applying it to an RRC message, according to an embodiment of the present disclosure.

With reference to FIG. 6, the UE 6-01 may be constituted of a mobile equipment (ME) 6-02 and a USIM 6-03, and may be separated into the USIM 6-03, which stores and manages information related to subscription information and policies, and the ME 6-02, which performs actual data transmission/reception and connection to the network. Initially, the UE may perform a cell-(re)selection procedure to camp on a serving cell in the RRC IDLE state 6-05. Once a specific base station (gNB) 6-04 is selected, the UE may determine if the cell is suitable and may camp on the cell to receive system information.

In step 6-10, a serving base station that supports integrity checking of the RRC messages through a new security key may generate a new MAC-I to which the shared security key (symmetric key or asymmetric key) described in FIG. 5 is applied. Before explaining the following procedure, the present disclosure explains a method of identifying whether the MAC-I is valid when receiving a new MAC-I from the base station.

As the first method, the case where an asymmetric key is used to determine the validity of MAC-I is explained.

When the base station broadcasts the new MAC-I information through system information, the base station and the core network may have a private key and may not share the private key. The public key may be provisioned through the USIM and the UE may acquire the public key through this USIM. (See FIG. 5) When the base station provides MAC-I information and area information in which the information is valid to the UE through a dedicated RRC message, the public key for checking the validity of MAC-I may be provisioned through USIM, and the UE may acquire it. (See FIG. 5) In addition, the valid area information may be at least one of the cell level, the tracking area (TA)/registration area (RA) level, or the RAN notification area (RNA) level.

As the second method, the case where a symmetric key is used to determine the validity of MAC-I is explained.

When the base station broadcasts the new MAC-I information through system information, the base station and core network may have a public key. In addition, the information may be shared (e.g., RRC message). The public key is provisioned through USIM and may be acquired by the UE. (See FIG. 5)

When the base station provides MAC-I information and area information in which the information is valid to the UE through a dedicated RRC message, the public key for checking the validity of MAC-I may be provisioned through USIM, and the UE may acquire it. Alternatively, the UE may receive a public key for checking the validity of MAC-I through an RRC message. The valid area information may be at least one of the cell level, the tracking area (TA)/registration area (RA) level, and the RAN notification area (RNA) level.

In step 6-15, the base station may include the new MAC-I information generated in the above steps in the system information and deliver it to the UE. In the present embodiment, as a method of delivering the new MAC-I information, the explanation is focused on the method in which the new MAC-I information is delivered using system information. However, it is not limited to this, and of course, this embodiment may be applied even when the new MAC-I information is delivered through a dedicated RRC message as described above.

As a method of delivering the new MAC-I information using system information, a method according to at least one of the following embodiments may be applied.

In an embodiment, the base station may deliver the new MAC-I information to the UE by including it in the SIB1 message. This is a method of extending the existing SIB1 and adding the newMAC-I field, allowing the base station to commonly broadcast the information to all UEs.

The UE that does not support this function cannot receive the extended system information and therefore may perform the existing operation without applying the new MAC-I information. The UE that supports this function may receive the extended information, apply the delivered MAC-I, and use it for the integrity checking. If the integrity check operation fails, the UE may perform a cell reselection procedure.

Table 1 shows an example of a candidate ASN.1 code according to an embodiment of the present disclosure.

With reference to Table 1, the SIB1 may contain information about new MAC-I (e.g., newMAC-I), the time (e.g., new Timer) in which the MAC-I information is valid, and/or the area (e.g., validarea) in which the MAC-I information is valid. For example, the unit of time (e.g., new Timer) for which the MAC-I information is valid may be the units in seconds or system frame numbers (SFNs), subframes, or slots. The area (e.g., validarea) in which the MAC-I information is valid may be configured at least one of the cell level, the tracking area (TA)/registration area (RA) level, or the RAN notification area (RNA) level.

In Table 1, the size of MAC-I is indicated as 16, but this is an example for the convenience of explanation and therefor the size of MAC-I may vary depending on the security key range. For example, it may have 32 bits.

TABLE 1

| | |
|---|---|
| SIB1-v18xy-IEs ::= | SEQUENCE { |
| newMAC-I | BIT STRING (SIZE (16))} |

OPTIONAL, -- Need R

| | |
|---|---|
| newTimer | Enumerated {s1, s2, s4, s8, s16, s32, s64, s128} OPTIONAL, -- |

Need R

| | |
|---|---|
| validArea | TrackingAreaCode OPTIONAL, -- Need R |
| nonCriticalExtension | SEQUENCE { } |

OPTIONAL
}

In another embodiment, the base station may deliver the new MAC-I information to the UE through the scheduling of separately delivered system information messages.

In this case, the new MAC-I may be included only in certain system information (SI) messages. For example, in the SI message in which MAC-I is generated, the sib-TypeAndInfo field may be set to a specific value.

For example, in sib1-v18xy, the SIB1 IE or the newly defined SIB X IE (where X is the number of the SIB) may be selected.

The BEARER, COUNT, and DIRECTION values used to generate the MAC-I may all be set to 1, or they may be set to other predetermined values. This contents may also be applied to all other methods belonging to the present embodiment.

The UE that does not support this function cannot receive the extended system information and therefore may perform the existing operation without applying the new MAC-I information. The UE that supports this function may receive the extended information, apply the delivered MAC-I, and use it for the integrity checking. If the integrity check operation fails, the UE may perform a cell reselection procedure. Table 2 shows an example of a candidate ASN.1 code according to an embodiment of the present disclosure.

With reference to Table 2, the SI message containing the new MAC-I information (e.g., newMAC-I) may include information about the time (e.g., new Timer) in which the MAC-I information is valid and/or the area (e.g., validarea) in which the MAC-I information is valid. For example, the unit of time (e.g., new Timer) for which the MAC-I information is valid may be the units in seconds or system frame numbers (SFNs), subframes, or slots. The area (e.g., validarea) in which the MAC-I information is valid may be configured at least one of the cell level, the tracking area (TA)/registration area (RA) level, or the RAN notification area (RNA) level.

In Table 2, the size of MAC-I is indicated as 16, but this is an example for the convenience of explanation and therefor the size of MAC-I may vary depending on the security key range. For example, it may have 32 bits.

TABLE 2

| | |
|---|---|
| SystemInformation-IEs ::= | SEQUENCE { |
| sib-TypeAndInfo | SEQUENCE (SIZE (1..maxSIB)) OF CHOICE { |
| sib2 | SIB2, |
| sib3 | SIB3, |
| sib4 | SIB4, |
| sib5 | SIB5, |
| sib6 | SIB6, |
| sib7 | SIB7, |
| sib8 | SIB8, |
| sib9 | SIB9, |

...,

| | |
|---|---|
| sib10-v1610 | SIB10-r16, |
| sib11-v1610 | SIB11-r16, |
| sib12-v1610 | SIB12-r16, |
| sib13-v1610 | SIB13-r16, |
| sib14-v1610 | SIB14-r16, |
| sib1-v18xy | SIB1 |

},

| | | |
|---|---|---|
| lateNonCriticalExtension | OCTET STRING | OPTIONAL, |
| nonCriticalExtension | SystemInformation-v18xy-IEs | SEQUENCE |

| | |
|---|---|
| { } | OPTIONAL |

}

| SystemInformation-v18xy-IEs ::= | SEQUENCE { | |
|---|---|---|
| newMAC-I | BIT STRING (SIZE (16))} | OPTIONAL, -- |

Need R

| | | |
|---|---|---|
| newTimer | Enumerated {s1, s2, s4, s8, s16, s32, s64, s128} | OPTIONAL, |

-- Need R

| | | |
|---|---|---|
| validArea | TrackingAreaCode | OPTIONAL, -- |

Need R

| | | |
|---|---|---|
| nonCriticalExtension | SEQUENCE { } | OPTIONAL |

}

In another embodiment, the new system information that delivers the new MAC-I information separately may be introduced. As an example, SIB1-Secured-IEs may be introduced to replace the function of SIB1. The UE that does not support this function cannot receive the extended system information and therefore may perform the existing operation without applying the new MAC-I information. The UE that supports this function may receive the extended information, apply the delivered MAC-I, and use it for the integrity checking. If the integrity check operation fails, the UE may perform a cell reselection procedure.

Table 3 shows an example of a candidate ASN.1 code according to an embodiment of the present disclosure.

With reference to Table 3, parameters such as SIB1-Secured-IEs may be introduced to deliver the new MAC-I information. The newly introduced system information (SIB1-Secured-IEs) may include information about the new MAC-I (e.g., newMAC-I), the time (e.g., new Timer) in which the MAC-I information is valid, and/or the area (e.g., validarea) in which the MAC-I information is valid. For example, the unit of time (e.g., new Timer) for which the MAC-I information is valid may be the units in seconds or system frame numbers (SFNs), subframes, or slots. The area (e.g., validarea) in which the MAC-I information is valid may be configured at least one of the cell level, the tracking area (TA)/registration area (RA) level, or the RAN notification area (RNA) level.

In Table 3, the size of MAC-I is indicated as 16, but this is an example for the convenience of explanation and therefor the size of MAC-I may vary depending on the security key range. For example, it may have 32 bits.

TABLE 3

| | |
|---|---|
| SIB1-Secured-IEs ::= | SEQUENCE { |

legacy fields...(or those could be skipped)

| | |
|---|---|
| newMAC-I | BIT STRING (SIZE (16))} |

OPTIONAL, -- Need R

| | |
|---|---|
| newTimer | Enumerated {s1, s2, s4, s8, s16, s32, s64, s128} OPTIONAL, -- |

Need R

| | |
|---|---|
| validArea | TrackingAreaCode OPTIONAL, -- Need R |
| nonCriticalExtension | SEQUENCE { } |

OPTIONAL
}

In another embodiment, the base station may deliver a new system information (e.g., SIBxy-IEs), which delivers the new MAC-I information separately, to the UE in an on-demand forn. As an example, the new system information (e.g., SIBxy-IEs) in an on-demand form may be introduced. The UE that does not support this function cannot request the on-demand system information and therefore may perform the existing operation without applying the new MAC-I information. The UE that supports this function may receive the system information through an on-demand system information request, apply the MAC-I included in the system information, and use it for the integrity checking. If the integrity check operation fails, the UE may perform a cell reselection procedure.

Table 4 shows an example of a candidate ASN.1 code according to an embodiment of the present disclosure.

With reference to Table 4, the on demand system information (e.g., SIBxy-IEs) may contain information about new MAC-I (e.g., newMAC-I), the time (e.g., new Timer) in which the MAC-I information is valid and/or the area (e.g., validarea) in which the MAC-I information is valid. For example, the unit of time (e.g., new Timer) for which the MAC-I information is valid may be the units in seconds or system frame numbers (SFNs), subframes, or slots. The area (e.g., validarea) in which the MAC-I information is valid may be configured at least one of the cell level, the tracking area (TA)/registration area (RA) level, or the RAN notification area (RNA) level.

In Table 4, the size of MAC-I is indicated as 16, but this is an example for the convenience of explanation and therefor the size of MAC-I may vary depending on the security key range. For example, it may have 32 bits.

TABLE 4

| | |
|---|---|
| SIBxy-IEs ::= | SEQUENCE { |
| newMAC-I | BIT STRING (SIZE (16))} |

OPTIONAL, -- Need R

| | |
|---|---|
| newTimer | Enumerated {s1, s2, s4, s8, s16, s32, s64, s128} OPTIONAL, -- |

Need R

| | |
|---|---|
| validArea | TrackingAreaCode OPTIONAL, -- Need R |
| nonCriticalExtension | SEQUENCE { } |

OPTIONAL
}

In step 6-20, the UE ME 6-02 may receive the system information broadcast by the base station and check whether the base station has the new security capability. If the UE also has such capability, it may receive the system information and apply the received MAC-I information and the time and area information for which the MAC-I information is valid. Based on the MAC-I verification key (public key) held by the UE, it can be determined whether the MAC-I broadcast by the base station is valid. In step 6-25, the UE ME 6-02 may request the USIM 6-03 to verify the received MAC-I.

In step 6-30, the USIM 6-03 may verify the received MAC-I by applying its public key to it. In addition, an expected Message Authentication Code-Integrity (XMAC-I) value (e.g., ResumeMAC-I) that can be applied to uplink messages (e.g., UECapabilityInformation, RRCResumeRequest) to be transmitted by the UE and that can be used when delivering MAC-I information, may be computed.

In step 6-35, the UE USIM may deliver the computed XMAC-I to the UE ME 6-02 through a message (e.g., a response message).

In step 6-40, the UE and the base station may perform the RRC connection establishment.

In step 6-45, the base station may apply the new MAC-I and deliver the UECapabilityEnquiry message to the UE.

In step 6-50, the UE may also perform an integrity check on the message by applying a new MAC-I (i.e., XMAC-I) and generate a UECapabilityInformation and deliver it to the base station.

In step 6-55, the AS security activation procedure may be newly triggered and the existing security activation operation may be performed, and if the AS security activation operation is omitted, the new security operation that was previously in use may continue to be performed. That is, the integrity checks used in the RRC reconfiguration procedure of the steps 6-60 and 6-65 may apply the security procedure established in the AS security activation procedure if the AS security activation operation 6-55 is performed, and the new security key and the MAC-I may still be used in steps 6-60 and 6-65 even if the AS activation operation 6-55 is not performed.

In step 6-70, the base station may transition the UE to the IDLE or INACTIVE state through the RRC release procedure. At this time, the RRCRelease message delivered to the UE may include at least one of the new MAC-I information, the valid area information, and the valid timer information that can be used as an enhanced security function (security enhancement of a specific RRC message) in the next connection attempt.

If the UE transitions to the RRC IDLE or INACTIVE state in step 6-75, at some point in time the UE may attempt an RRC connection procedure, and in step 6-80 the device may start an RRC connection establishment (RRCSetupRequest) or resume (RRCResumeRequest) procedure. The message may consist of information associated with the new MAC-I received in the previous RRCRelease message, and if the release message does not contain such information, a value broadcast from the previous cell or from the system information of the cell currently attempting to establish the connection may be used. In step 6-85, the base station may reject the connection attempt by the UE through an RRCReject message, and may also send this message with enhanced security. That is, it may be delivered by applying the new MAC-I.

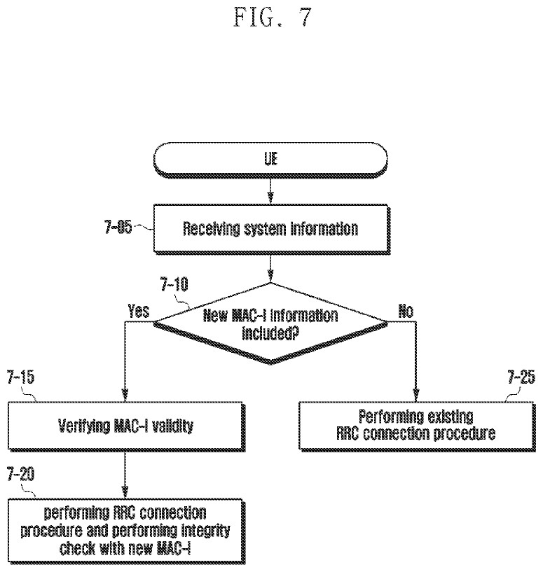

FIG. 7 is a diagram illustrating a UE operation supporting an enhanced security function when a new MAC-I is included in a system information, according to an embodiment of the present disclosure. The detailed operation may follow that of FIG. 6.

In step 7-05, the UE may receive system information from the camp-on serving cell. In step 7-10, the UE may identify whether the system information includes the new MAC-I information (information required to perform integrity checks on a particular RRC message). If the new MAC-I information is included, the UE may verify the received MAC-I with its public key 7-15 and, if the MAC-I is determined to be valid, the UE may perform the RRC connection procedure in step 7-20 and perform the integrity check with the new MAC-I. In addition, if the MAC-I is determined to be invalid, the UE may trigger the cell reselection procedure.

If the system information in step 7-10 does not include the MAC-I information, the UE may perform the existing RRC connection procedure in step 7-25 without using the enhanced security function (performing an integrity check on a specific RRC message through the new MAC-I).

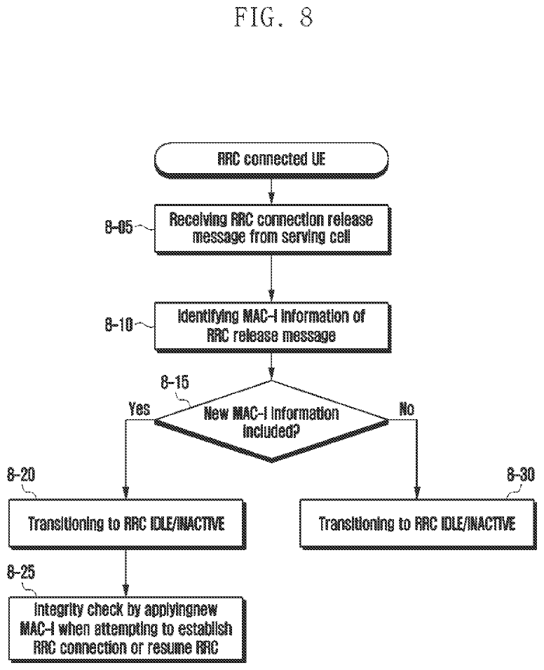

FIG. 8 is a diagram illustrating a UE operation supporting an enhanced security function when a new MAC-I is included in a dedicated RRC message, according to an embodiment of the present disclosure.

In step 8-05, the UE may receive an RRC connection release message from the serving cell. Prior to step 8-05, the UE may be in the RRC connection state.

In step 8-10, the UE may identify whether the RRC release message includes the MAC-I information (information required to perform an integrity check on a specific RRC message) used by the enhanced security function.

If the information is included, the UE may transition to the RRC state indicated in step 8-20 (transition to RRC IDLE or RRC INACTIVE may be indicated in the RRC release message). In step 8-25, the UE may deliver the message by applying the new MAC-I when attempting to establish an RRC connection or resume an RRC. The detailed operation may refer to the description of FIG. 6.

If the RRCRelease message in step 8-15 does not include the new MAC-I information, the UE may transition to the RRC state indicated in step 8-30 (transition to RRC IDLE or RRC INACTIVE may be indicated in the RRC release message).

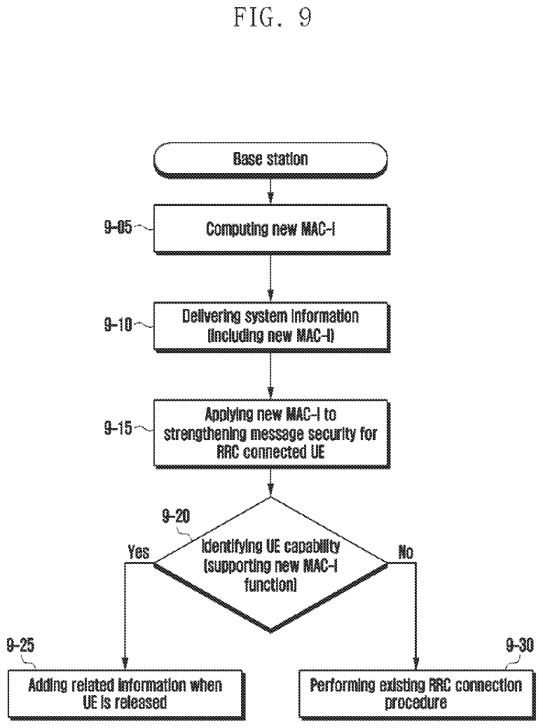

FIG. 9 is a diagram illustrating the overall operation of a base station supporting an enhanced security function when a new MAC-I is included, according to an embodiment of the present disclosure.

In step 9-05, a base station that supports the enhanced security function (performing an integrity check on a specific RRC message through the new MAC-I) may generate a new MAC-I based on the key provided by the home network. This is for an enhanced security function and may be used to perform an integrity check when transmitting and receiving the specific message.

In step 9-10, the base station may broadcast system information including the new MAC-I. For the detailed description of generating and broadcasting system information, the description of FIG. 6 may be referred to.

In step 9-15, the base station may apply the new MAC-I afterwards to strengthening the message security for the RRC connected UE that supports an enhanced security function.

In step 9-20, the UE capability may be identified whether it supports the enhanced security function. If the UE supports the enhanced security function, the new MAC-I related information may be updated when the UE is released in the step 9-25. However, if the UE does not support the function, the RRC release as per the existing procedure may be performed.

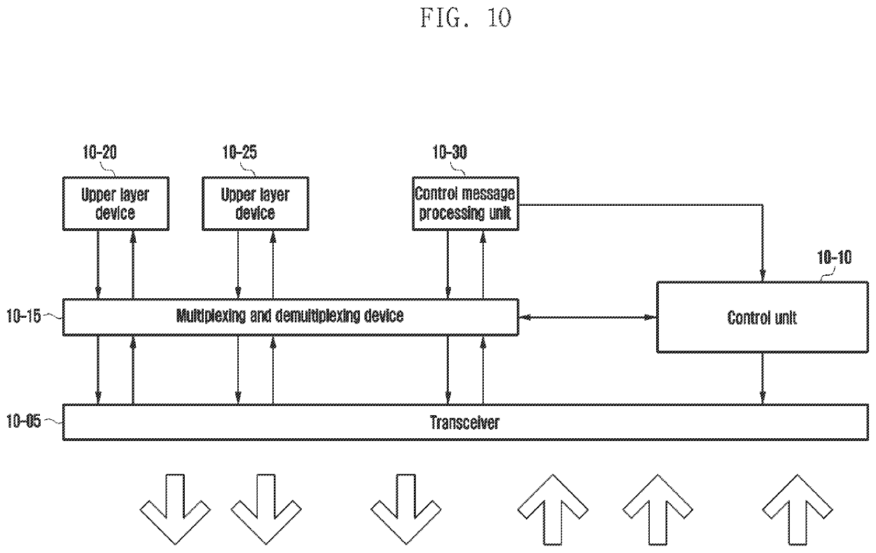

FIG. 10 is a diagram illustrating a block configuration of a UE according to an embodiment of the present disclosure.

With reference to FIG. 10, the UE may include a transceiver 10-05, a control unit 10-10, a multiplexing and demultiplexing unit 10-15, respective upper layer processing units 10-20 and 10-25, and a control message processing unit 10-30.

The transceiver 10-05 may receive data and predetermined control signals on the forward channel of the serving cell and transmit data and predetermined control signals on the reverse channel. When multiple serving cells are configured, the transceiver 10-05 may perform transceiving of the data and the control signals through multiple service cells. The multiplexing and demultiplexing unit 10-15 may serve to multiplex data generated by the upper layer processing units 10-20 and 10-25 or the control message processing unit 10-30, or to demultiplex data received from the transceiver unit 10-05 and deliver it to the appropriate upper layer processing units 10-20 and 10-25 or the control message processing unit 10-30.

The control message processing unit 10-30 may perform necessary operations by transceiving control messages from the base station. This includes the ability to process control messages such as RRC messages and MAC CE, reporting CBR measurements, and receiving RRC messages about resource pools and UE operations.

The upper layer processing units 10-20 and 10-25 may mean the DRB devices and may be configured on a per-service basis. They may process data generated by user services such as File Transfer Protocol (FTP) or Voice over Internet Protocol (VoIP) and deliver it to the multiplexing and demultiplexing unit 10-15, or process data delivered from the multiplexing and demultiplexing unit 10-15 and deliver it to upper layer service applications.

The control unit 10-10 may control the transceiver 10-05 and the multiplexing and demultiplexing unit 10-15 so that the reverse transmission is performed at an appropriate time and with an appropriate resource by identifying the scheduling commands, such as reverse direction grants, received through the transceiver 10-05. For example, the control portion 10-10 may be configured to acquire information including a MAC-I in an RRC idle state, verify the MAC-I, and perform a procedure for the RRC connection with a base station if the MAC-I is valid on the basis of the verification.

On the other hand, although it has been described above that the UE is constituted of multiple blocks and each block performs a different function, this is only one embodiment and is not necessarily limited thereto. For example, the functions performed by the demultiplexing unit 10-15 may be performed by the control portion 10-10 itself.

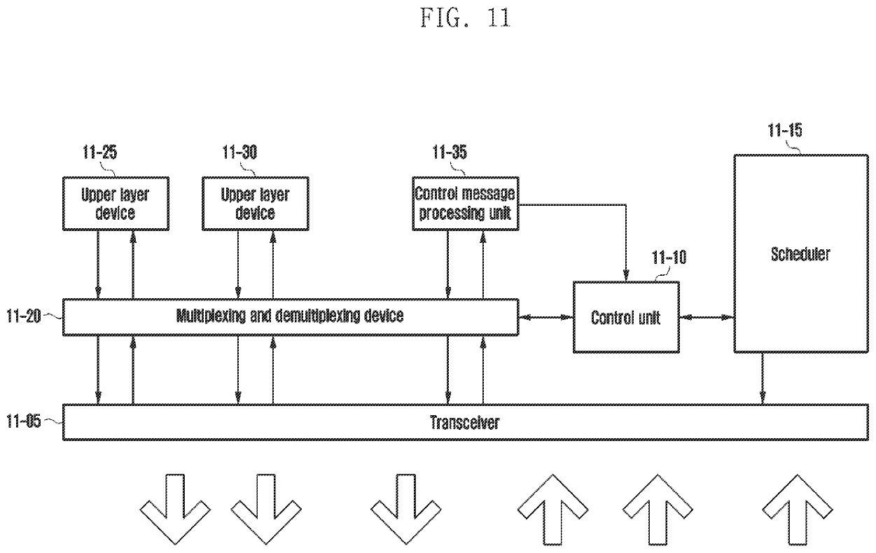

FIG. 11 is a diagram illustrating a block configuration of a base station according to an embodiment of the present disclosure.

With reference to FIG. 11, the base station may include a transceiver 11-05, a control unit 11-10, a multiplexing and demultiplexing unit 11-20, a control message processing unit 11-35, respective upper layer processing units 11-25 and 11-30, and a scheduler 11-15.

The transceiver 11-05 may transmit data and predetermined control signals on a forward carrier and receive data and a predetermined control signal on a reverse carrier. When multiple carriers are configured, the transceiver 11-05 may perform transceiving of the data and the control signals through multiple service cells. The multiplexing and demultiplexing unit 11-20 may serve to multiplex data generated by the upper layer processing units 11-25 and 11-30 or the control message processing unit 11-35, or to demultiplex data received from the transceiver 11-05 and deliver it to the appropriate upper layer processing units 11-25 and 11-30 or the control message processing unit 11-35 or the control unit 11-10.

The control message processing unit 11-35 may receive instructions from the control unit, generate messages to be delivered to the UE, and deliver them to the lower layers. The upper layer processing units 11-25 and 11-30 may be configured for UE-specific services, and may process data generated by user services such as FTP or VoIP and deliver it to the multiplexing and demultiplexing unit 11-20, or process data delivered from the multiplexing and demultiplexing unit 11-20 and deliver it to upper layer service applications.

The scheduler 11-15 may allocate transmission resources to the UEs at appropriate times, taking into account the buffer state of the UEs, the channel state, and the active time of the UEs, and may process the signals transmitted by the UEs to the transceiver or enable the signals to be transmitted to the UEs.

The control unit 11-10 may control each block of the base station. For example, the control unit 11-10 may be configured to determine a MAC-I to be transmitted to a UE in the RRC idle state, and to transmit information including the determined MAC-I to the UE.

Meanwhile, although the base station has been described above as consisting of multiple blocks, each of which performs a different function, this is only an example and not necessarily limited thereto. For example, some blocks may be combined to form a single block, or some blocks may be omitted.

Methods according to embodiments described in the claims or specification of the present disclosure may be implemented in the form of hardware, software, or a combination of hardware and software.

When implemented as software, a computer-readable storage medium that stores one or more programs (software modules) may be provided. One or more programs stored in a computer-readable storage medium are configured to be executable by one or more processors in an electronic device (configured for execution). One or more programs include instructions that enable the electronic device to execute methods according to embodiments described in the claims or specification of the present disclosure.

These programs (software modules, software) may be stored in random access memory, non-volatile memory including flash memory, read only memory (ROM), and electrically erasable programmable read only memory (EEPROM), magnetic disc storage device, Compact Disc-ROM (CD-ROM), Digital Versatile Discs (DVDs), or other types of optical storage device or magnetic cassette. Alternatively, it may be stored in a memory consisting of a combination of some or all of these. In addition, each configuration memory may include multiple units.

In addition, the program may be operated through a communication network such as an Internet, an Intranet, a local area network (LAN), a wide LAN (WLAN), or a storage area network (SAN), or a combination thereof. It may be stored on an attachable storage device that is accessible. This storage device may be connected to a device performing an embodiment of the present disclosure through an external port. In addition, a separate storage device on a communication network may be connected to the device performing an embodiment of the present disclosure.

In the specific embodiments of the present disclosure described above, components included in the disclosure are expressed in singular or plural numbers depending on the specific embodiment presented. However, as the singular or plural expressions are selected to suit the presented situation for convenience of explanation, the present disclosure is not limited to singular or plural components, and even the components expressed in plural may be composed of the singular elements and even components expressed in singular may be composed of plural elements.

On the other hand, the embodiments of the present disclosure disclosed herein and in the drawings are presented by way of specific examples only to illustrate the technical content of the present disclosure and to facilitate understanding of the present disclosure, and are not intended to limit the scope of the present disclosure. That is, it will be apparent to a person having an ordinary knowledge in the art to which the present disclosure belongs that other modifications based on the technical ideas of the present disclosure may be practiced. Furthermore, each of the above embodiments may be operated in combination with each other as needed. For example, base stations and UEs may be operated with portions of an embodiment of the present disclosure and other embodiments in combination with each other. In addition, the embodiments of the present disclosure are applicable to other communication systems, and other variations based on the technical ideas of the embodiments will also be possible. For example, the embodiments may be applicable to LTE systems, 5G or NR systems, and the like.

1. A method performed by a UE in a wireless communication system, the method comprising:
acquiring information including a Message Authentication Code for Integrity (MAC-I) in a radio resource control (RRC) idle state;
performing a verification for the MAC-I; and
performing a procedure for an RRC connection with a base station in case that the MAC-I is valid based on the verification.

2. The method of claim 1, further comprising:
receiving, from the base station, UE capability request information to which the MAC-I is applied, before access stratum (AS) security is activated; and
transmitting UE capability information to the base station in case that an integrity check based on the MAC-I is successful.

3. The method of claim 1, wherein the information including the MAC-I is included in system information or a dedicated RRC message transmitted from the base station.

4. The method of claim 1, wherein the information including the MAC-I further includes at least one of information on a time when the MAC-I is valid and information on an area in which the MAC-I is valid.

5. The method of claim 4,
wherein the time when the MAC-I is valid is configured in units of one of a system frame number (SFN), a subframe, or a slot; and
wherein the area in which the MAC-I is valid is configured in units of one of a cell, a tracking area (TA), a registration area (RA), or a RAN notification area (RNA).

6. The method of claim 1,
wherein acquiring information including the MAC-I includes:
transmitting a request message for the information to the base station; and
receiving, as a response to the request message, on-demand system information including the information.

7. A method performed by a base station in a wireless communication system, the method comprising:
determining a Message Authentication Code for Integrity (MAC-I) to be transmitted to a UE in a radio resource control (RRC) idle state; and
transmitting information including the determined MAC-I to the UE,
wherein a procedure for an RRC connection with the UE is performed in case that the MAC-I is valid.

8. The method of claim 7, further comprising:
transmitting UE capability request information to which the MAC-I is applied to the UE, before access stratum (AS) security is activated; and
receiving UE capability information from the UE in case that an integrity check based on the MAC-I is successful.

9. The method of claim 7, wherein the information including the MAC-I is transmitted through system information or a dedicated RRC message.

10. The method of claim 7,
wherein the information including the MAC-I further includes at least one of information on a time when the MAC-I is valid and information on an area in which the MAC-I is valid,
wherein the time when the MAC-I is valid is configured in units of one of a system frame number (SFN), a subframe, or a slot; and
wherein the area in which the MAC-I is valid is configured in units of one of a cell, a tracking area (TA), a registration area (RA), or a RAN notification area (RNA).

11. The method of claim 7,
wherein transmitting information including the determined MAC-I to the UE includes:
receiving a request message for the information from the UE; and
transmitting, as a response to the request message, on-demand system information including the information.

12. A UE in a wireless communication system comprising:
a transceiver; and
a controller configured to:
in a radio resource control (RRC) idle state, acquire information including a Message Authentication Code for Integrity (MAC-I),
perform a verification for the MAC-I, and
perform a procedure for an RRC connection with a base station in case that the MAC-I is valid based on the verification.

13. The UE of claim 12, wherein the controller is further configured to:
receive, from the base station, UE capability request information to which the MAC-I is applied, before access stratum (AS) security is activated; and
transmit UE capability information to the base station in case that an integrity check based on the MAC-I is successful,
wherein the information including the MAC-I is included in system information or a dedicated RRC message transmitted from the base station.

14. The UE of claim 12,
wherein the information including the MAC-I further comprises at least one of information on a time when the MAC-I is valid and information on an area in which the MAC-I is valid,
wherein the time when the MAC-I is valid is configured in units of one of a system frame number (SFN), a subframe, or a slot; and
wherein the area in which the MAC-I is valid is configured in units of one of a cell, a tracking area (TA), a registration area (RA), or a RAN notification area (RNA).

15. A base station in a wireless communication system comprising:
a transceiver; and
a controller configured to:
determine a Message Authentication Code for Integrity (MAC-I) to be transmitted to a UE in a radio resource control (RRC) idle state, and
transmit information including the determined MAC-I to the UE,
wherein a procedure for an RRC connection with the UE is performed in case that the MAC-I is valid.
